(19) United States
(12) Patent Application Publication
(10) Pub. No.: US 2007/0088659 A1
(43) Pub. Date: Apr. 19, 2007

(54) Distribution of selected digitally-encoded content to a storage device, user device, or other distribution target with concurrent rendering of selected content

(75) Inventor: Mark Phillips, Seattle, WA (US)

Correspondence Address: OLYMPIC PATENT WORKS PLLC, P.O. BOX 4277, SEATTLE, WA, 98104, US

(73) Assignee: MOD Systems

(21) Appl. No.: 11/253,961

(22) Filed: Oct. 19, 2005

(51) Int. Cl. G06Q 99/00

(52) U.S. Cl. 705/51; 705/1

(57) ABSTRACT

Various embodiments of the present invention provide selected content rendering, by a kiosk-based content-retailing system, or other content-retailing or content-distribution system, while selected content is being downloaded to a user device, written to a content-storage medium, or otherwise distributed to a target distribution medium. By concurrently rendering content and distributing content, the kiosk-based, content-retailing system, or other content-distribution system, provides a desirable distraction and entertainment to a retail customer who may otherwise need to wait idly at the kiosk for completion of the content distribution.

### TECHNICAL FIELD

The present invention is related to distribution of content, such as music, multi-media presentations, and video and, in particular, to a kiosk distribution system, or other distribution system, that distributes selected content to a user device, storage medium, or other distribution target while rendering the content, or a portion of the content, to a user.

### BACKGROUND OF THE INVENTION

Distribution of content, such as recorded music, recorded video, text, executable programs, and other such content has rapidly evolved during the past ten years. As few as 30 years ago, the primary means for distributing content were vinyl records, printed books, magnetic tapes, photographs, and celluloid movie films. All of these content-distribution media were analog in nature, and production of content for distribution involved fairly elaborate, time-consuming, and resource-consuming manufacturing processes. With the introduction of personal computers, in the late 1970's, and rapid adoption by consumers of digital content-distribution media, made possible by widespread consumer access to personal computers, the older analog content-distribution media were rapidly overtaken, and generally replaced by, digitally-encoded content stored on magnetic floppy drives, compact disks, DVD's, and, more recently, downloaded through the Internet to user devices featuring large, non-volatile memories, including the iPod®. The evolution of content-distribution media has, in turn, launched a revolution in methods and venues for retailing content. For example, CDs were initially retailed in retail stores much like vinyl records were retailed prior to the development and adoption of CDs. With the emergence of Internet-based retailing, a larger fraction of CDs are now sold through the Internet by various Internet retailers. However, there is still a strong demand, and strong market potential, for retailing CDs in public retail settings, particularly when retailing methods allow users to personalize, or design, the CDs that they purchase and when the content can be delivered electronically from databases and file servers directly to a CD produced at the retail location, rather than delivered on already-manufactured CDs via distribution centers to large retailers.

FIG. 1 illustrates one possible retail method for retailing digitally encoded content by distributing digitally encoded content to various types of target media, including CDs and DVDs. FIG. 1 shows a kiosk-based retailing system 100 comprising a touch-screen display device 102, headphones 104, a CD-burning and/or DVD-burning device 106, and a networked computer 108 that executes control programs that manage the kiosk system and that is interconnected with database systems, file servers, and other systems that store and distribute digitally encoded content. A kiosk-based content retailing system may be placed in any of numerous different types of retail establishments, may be implemented using application programs on personal computers in homes, in other residential settings, or in various other non-commercial settings, and may be additionally implemented and located in a variety of additional types of public or private settings. Many different possible configurations of kiosk-bases retailing systems, using various different components, are possible. The touch-screen display device allows a user to interact with the kiosk system in order to select and control various services offered by the kiosk system. In certain implementations, a user may begin interacting with the kiosk by touching a “push to start” button 110 displayed by the touch-screen display device 102.

FIGS. 2A-G illustrate an exemplary user interaction with a digitally-encoded-content-retailing kiosk leading to the design and purchase of an audio CD by a user. As shown in FIG. 2A, the kiosk responds to initiation of user interaction, via the above-described “push to start” button by displaying a high-level menu 202 from which the user can select, by touch-key entry, one of a number of different services offered by the kiosk system. As shown in FIG. 2A, the kiosk may offer access to various types of textual and multimedia information, may offer on-line shopping from one or more catalogs or on-line stores, and may offer the user an opportunity to design and purchase a CD that is produced by the kiosk and directly delivered to the user, in real time. When the user selects the CD designing and purchasing service 204, the kiosk may display an artist-selection screen, as shown in FIG. 2B. The artist-selection screen allows the user to select the first letter of the name of a desired artist or musical group whom the user wishes to include on the CD that the user is designing. When the user selects a particular first letter, such as the letter “D” 206, the kiosk displays a lower-level artist-selection menu listing the artists with names that begin with the selected letter. The kiosk may display up and down scrolling buttons 208 and 210 to allow the user to scroll through the list. When the user selects a particular artist via a touch-key button 212, the kiosk displays a list of musical selections created by the artist in a music-selection screen, such as music-selection screen 214 shown in FIG. 2D. The user can select one or more songs or pieces from the displayed list and, by touching the “add to CD” button 216, can direct the kiosk to add the one or more selections to a list of music selections for the CD that the user is designing. Following adding of music selections to the musical-selection list, the kiosk may display a “my CD” screen, shown in FIG. 2E, to allow the user to view the current list of music selections for the CD that the user is designing. The user can choose to have the kiosk produce the CD, by touching the “make CD” touch-entry button 218, to add additional musical selections, by touching the “add to CD” touch-screen button 220, or to edit the current list by additional touch-screen features not shown in FIG. 2E. Choosing to add additional music selections causes the kiosk to again display the artist-selection screen shown in FIG. 2B. Once the user decides to have the CD produced by the kiosk, via the “make CD” touch-entry button, the kiosk may display a checkout screen, shown in FIG. 2F, to allow the user to enter purchasing information and, once the purchasing information is verified, to indicate, by touching the “burn CD now” touch-screen button 222, that the user now wishes to receive the CD.

Once the user has directed the kiosk to produce the CD, the kiosk may display a “waiting for CD” screen, as shown in FIG. 2G, and then proceed to locate the selected musical content and queue the selected musical content for writing to a CD mounted within a CD-writing device. Unfortunately, particularly for lengthy CDs and DVDs, the writing operation may consume several minutes or tens of minutes of time. During that time, the user may become bored or distracted and increasingly impatient. In certain kiosk-based content-retailing implementations, the user may return to the high-level menu, shown in FIG. 2A, and avail himself or herself of additional services, such as access to news or other information. But the user may not be interested in these services, and certain kiosk implementation may not allow for new services to be rendered by the kiosk until a current service has finished. For these reasons, designers, manufacturers, retailers, and users of kiosk-based content-retailing systems have recognized the need for methods and techniques for occupying a user, and entertaining a user, while a CD or DVD is produced by the kiosk system.

### SUMMARY OF THE INVENTION

Various embodiments of the present invention provide selected content rendering, by a kiosk-based content-retailing system, or other content-retailing or content-distribution system, while selected content is being downloaded to a user device, written to a content-storage medium, or otherwise distributed to a target distribution medium. By concurrently rendering content and distributing content, the kiosk-based, content-retailing system, or other content-distribution system, provides a desirable distraction and entertainment to a retail customer who may otherwise need to wait idly at the kiosk for completion of the content distribution.

### BRIEF DESCRIPTION OF THE DRAWINGS

FIG. 1 illustrates one possible retail method for distributing digital content to various types of target media, including CDs and DVDs.

FIGS. 2A-G illustrate an exemplary user interaction with a digitally-encoded-content-retailing kiosk leading to the design and purchase of an audio CD by a user.

FIG. 3 shows an alternative “waiting-for-CD” screen displayed by a kiosk-based content-retailing system incorporating one embodiment of the present invention, rather than the “waiting-for-CD” screen shown in FIG. 2G in the exemplary user interaction typical of currently available kiosk-based systems.

FIGS. 4A-C show control-flow diagrams that illustrate one implementation of an audio-content distribution method on a kiosk-based content-retailing system that incorporates the present invention.

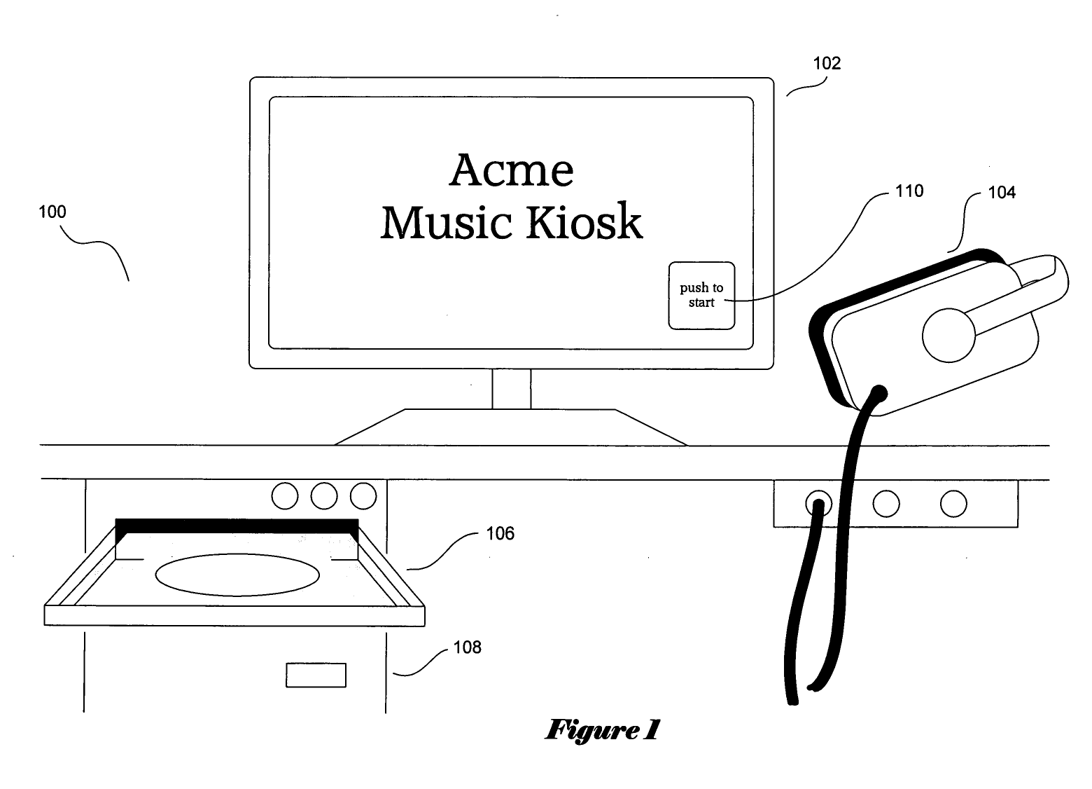

### DETAILED DESCRIPTION OF THE INVENTION

Embodiments of the present invention are directed to content-retailing and content-distribution systems that concurrently distribute selected content to users while rendering the selected content to users in order to entertain and occupy the users during content distribution. The described embodiment concerns kiosk-based content-retailing systems that allow a user to design an audio CD or DVD that is produced, in real time, for the user by the kiosk-based system. However, the present invention may be incorporated into a variety of content-distribution systems that distribute many different types of digitally encoded content to a variety of different types of users through a variety of different retailing and distribution systems. The distributed content may include, in addition to audio music selections, video, movies, executable programs, photographs, multimedia presentations, computer games, and any of a myriad of different renderable, digitally encoded information. In all cases, the content-distribution system, according to the present invention, renders the selected content, or a portion of the selected content, to the user during content distribution. In the case of a movie, the content-distribution system may visually display the movie, on a display device, and provide the soundtrack for the movie on headphones or speakers. In the case of a computer game, the content-distribution system may allow a user to play the game, using user-input devices while watching graphics displayed on a display device.

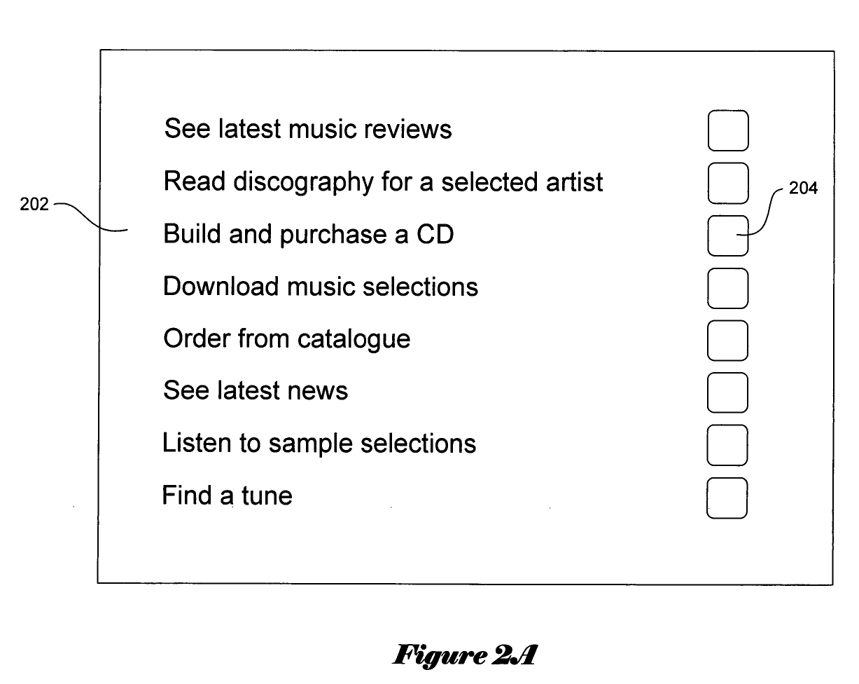

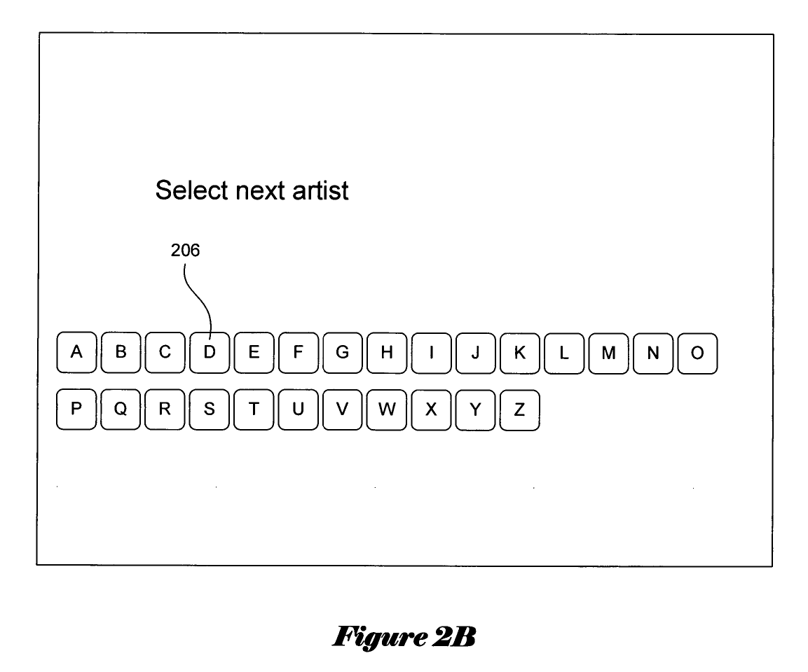

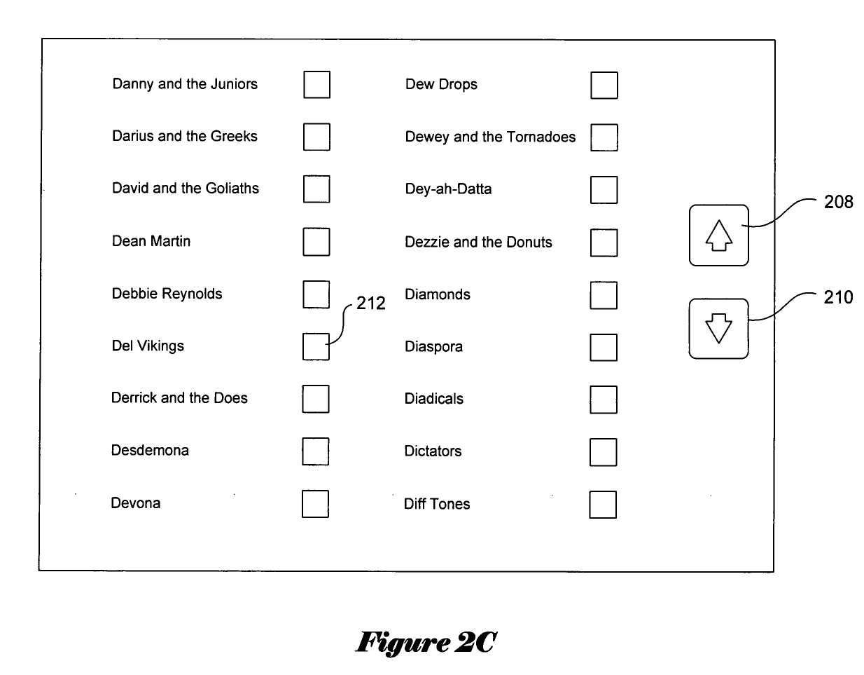

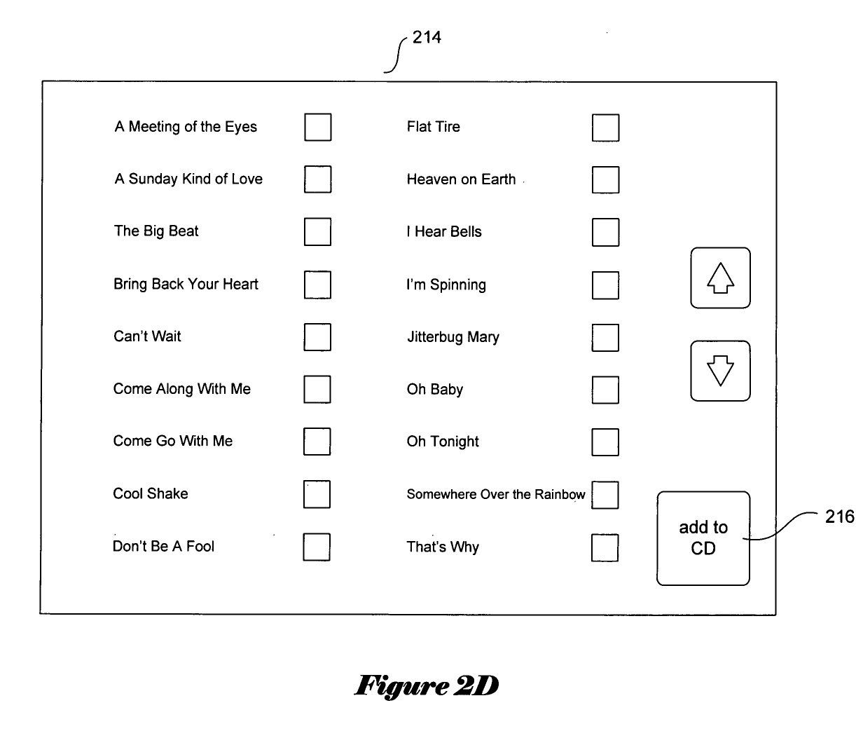

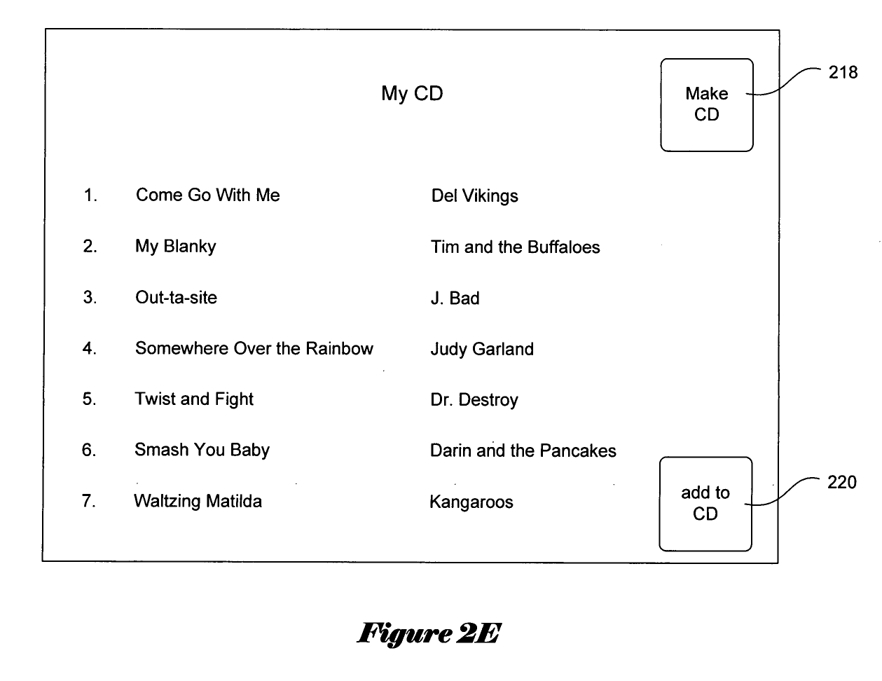

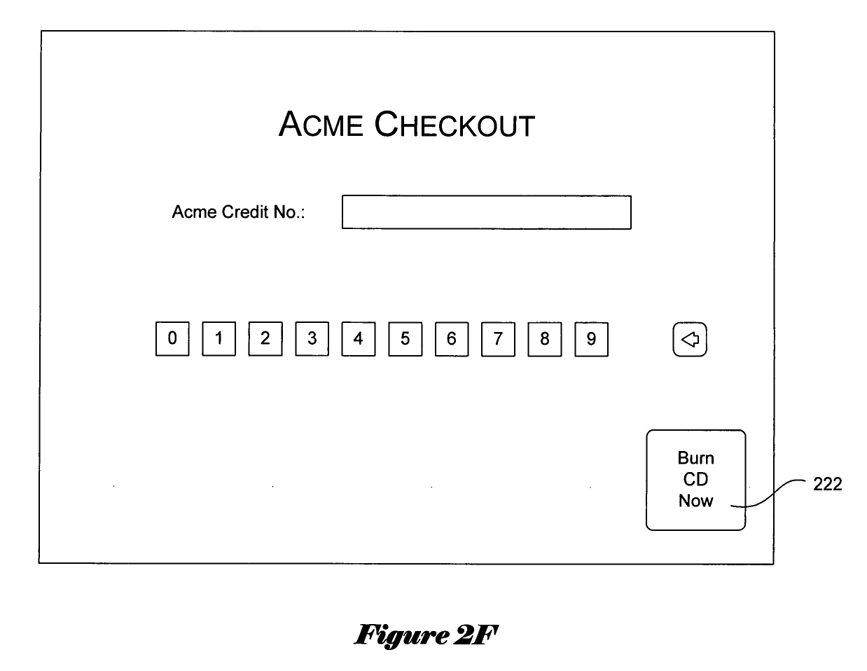

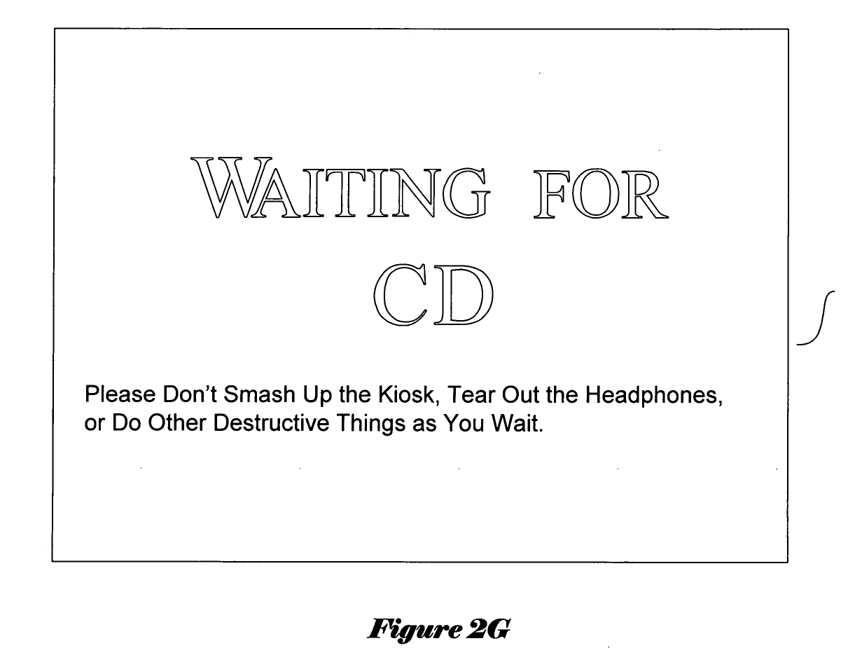

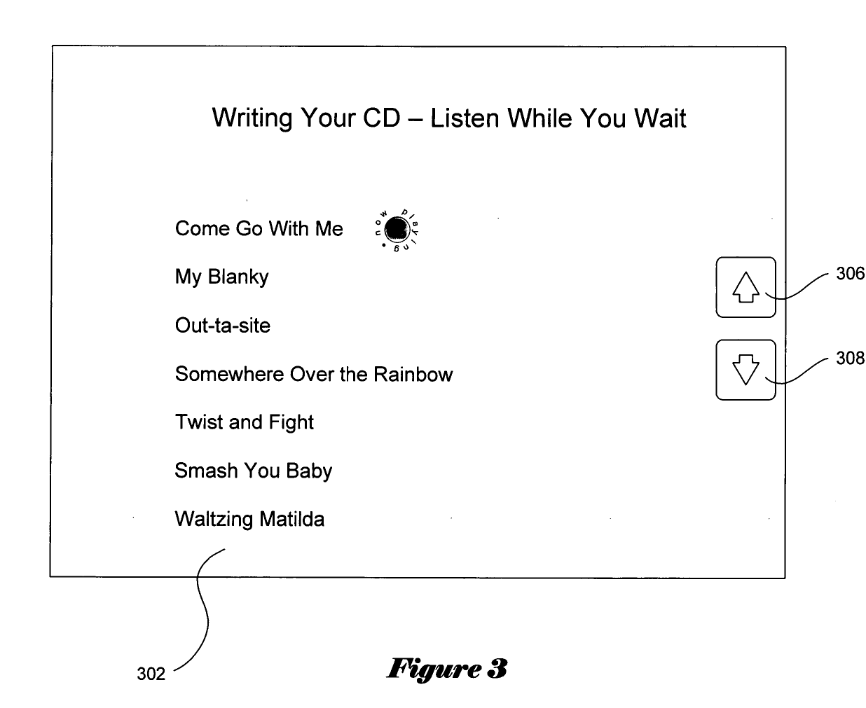

FIG. 3 shows an alternative “waiting-for-CD” screen displayed by a kiosk-based content-retailing system incorporating one embodiment of the present invention, rather than the “waiting-for-CD” screen shown in FIG. 2G in the exemplary user interaction typical of currently available kiosk-based systems. In the “waiting-for-CD” display screen displayed by kiosk-based content-distribution system employing methods of the current invention, a list of the selected content being written to CD by the kiosk system 302 is displayed to the user, with a graphical indication 304 indicating a musical selection that is currently being rendered by the kiosk system for listening by the user. The kiosk-based system plays a musical selection through headphones or speakers available to the user at the kiosk. The “waiting-for-CD” screen includes user-input touch-screen buttons 306 and 308 that allow a user to interrupt rendering of a particular musical selection and launch rendering of a previous or next musical selection from the displayed list, with the selections wrapping from the bottom of the list to top of the list and from top of the list to bottom of the list. The kiosk may render only a portion of the musical selections to the user, while the user waits for the CD to be written, or it may render entire selections. Various different implementations of kiosk-based systems that incorporate the present invention may include additional user-input features to allow a user to control volume, tone quality, speed of content rendering, and various other such parameters. As discussed above, although the presently discussed example concerns distribution of audio content to CD and DVD distribution media, other types of distributed content may be rendered to a user, and the equivalent “waiting-for-distribution” screen may include additional features and user-selectable parameters to appropriately control rendering of the different types of content, including video, movies, game sequences, and other such rendered content.

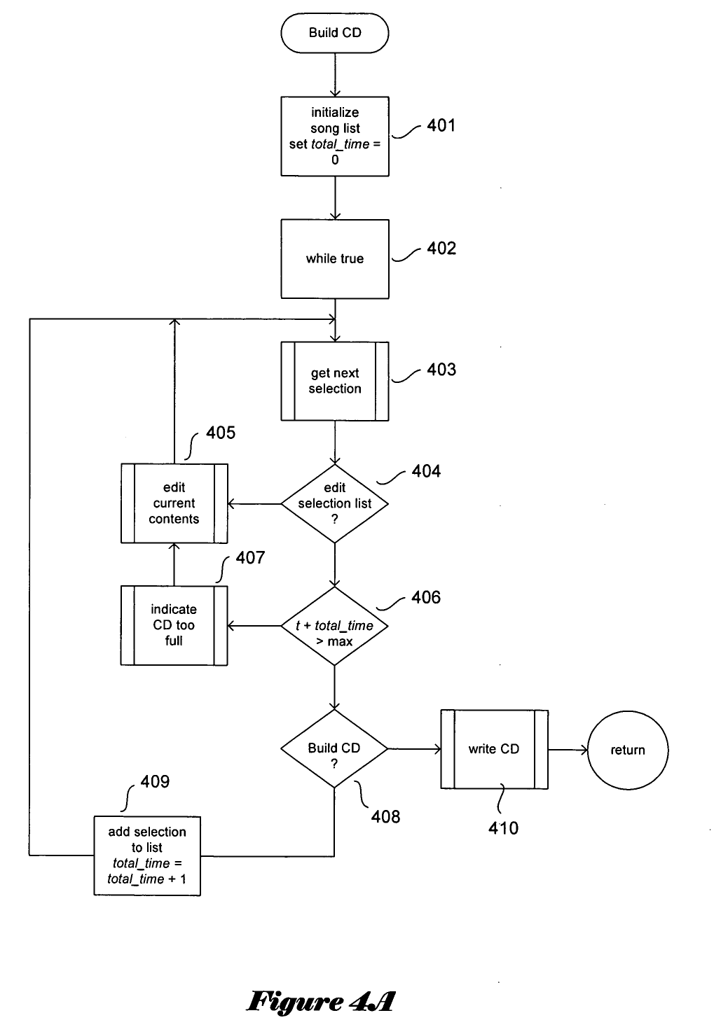

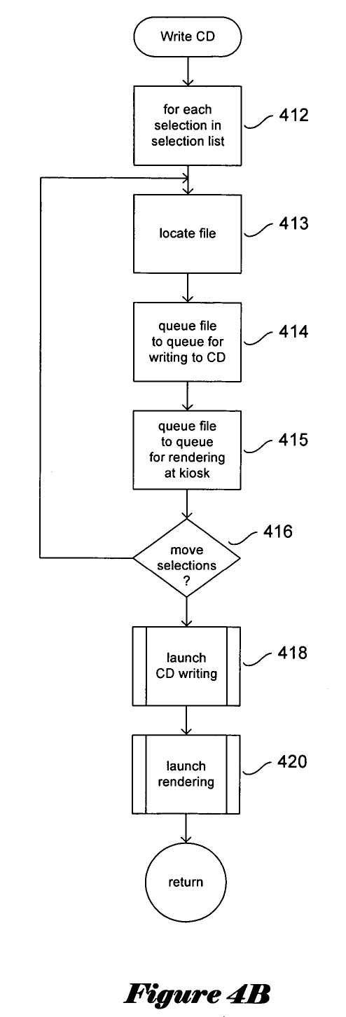

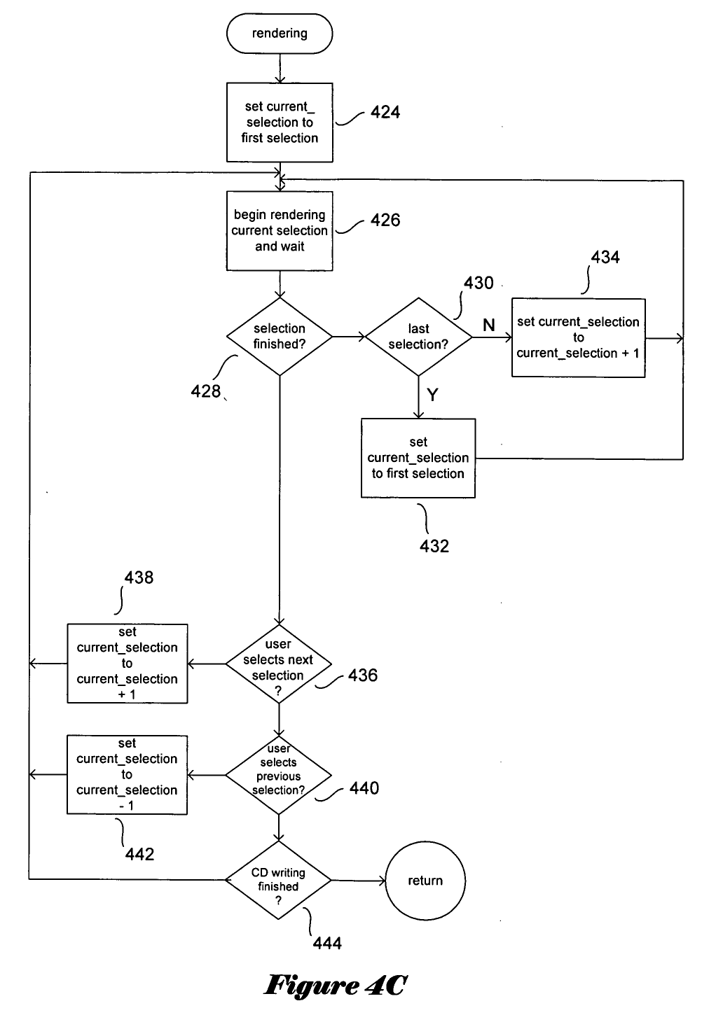

FIGS. 4A-C show control-flow diagrams that illustrate one implementation of an audio-content distribution method on a kiosk-based content-retailing system that incorporates the present invention. FIG. 4A shows a control-flow diagram for a routine “buildCD” that controls a CD designing and production service that may be selected by a user of a kiosk-based content-retailing system. In step 401, a song list is initialized, and a variable total_time is set to 0. Next, in the while-loop of steps 402-409, the routine “buildCD” solicits music selections from the user and compiles a list of songs that the user wishes to be written to the CD that the user intends to purchase. In step 403, the routine “buildCD” displays the appropriate display screens, and collects appropriate user input, in order to either receive a next musical selection, or to receive various other user input. If the user wishes to edit the selection list, as indicated by user input received during step 403, as determined in step 404, then the routine “buildCD” edits the current contents of the song list as directed by the user, in step 405, and control then returns to step 403 for receiving additional user input. If the length, in time, of the next selection t added to the current value stored in a variable total_time produced a time greater than the maximum allowable content-playing time for writing to a CD, as determined in step 406, then the routine “buildCD” indicates to the user that the list of music selections represents content that is too large to accommodate the next selection, in step 407, allows a user to edit the current contents, if desired by the user, to make room for the desired selection, in step 405, and then solicits additional user input in step 403. Otherwise, if the user has indicated that the user wishes the CD to be produced with the current song list, as determined by the routine “buildCD” in step 408, then control exits the while-loop of steps 402-409, and a routine “writeCD” is called, in step 410, to complete distribution of the selected song list to the CD. Otherwise, the variable total_time is updated, in step 409, and the current selection is added to the list of music selections for the user.

FIG. 4B is a control-flow diagram for the routine “writeCD,” called in step 410 in FIG. 4A. In the for-loop of steps 412-416, the routine “writeCD” locates the file or other object that contains the content represented by the next selection in the selection list, in step 413, queues the file for writing to the CD in step 414, and additionally queues the file for rendering to the user by the kiosk in step 415. When all selections in the selection list have been queued, the routine “writeCD” launches CD writing, in step 418, and launches rendering of the selections in step 420. These two activities are asynchronous, and execute concurrently.

FIG. 4C is a control-flow diagram for the content-rendering routine called in step 420 of FIG. 4B. In step 424, the rendering routine sets a variable current_selection to the first selection queued for rendering. Next, in step 426, the rendering routine begins rendering the current selection and waits for any of various events to occur. If the next-occurring event corresponds to completion of rendering of the current selection, as determined in step 428, then, if the current selection is the last selection in the selection list, as determined in step 430, the rendering routine sets the variable current_selection to the first selection in the selection list in step 432. Otherwise, the rendering routine sets the current_selection variable to the next selection in the selection list, in step 434. In both cases, control flows back to step 426, where rendering of the new current selection is launched by the rendering routine. If the event corresponds to a user selecting the next selection of the selection list, as detected in step 436, then the rendering routine accordingly updates the variable current_selection, in step 438, and control returns to step 426. Similarly, if the event corresponds to a user selecting a previous selection from the selection list, as determined in step 440, then the rendering routine accordingly updates the variable current_selection, in step 442, and control flows back to step 426. If the event corresponds to the CD having been completely written, as determined in step 444, then the rendering routine finishes.

Although the present invention has been described in terms of a particular embodiment, it is not intended that the invention be limited to this embodiment. Modifications within the spirit of the invention will be apparent to those skilled in the art. For example, as discussed above, kiosk-based retailing systems may include many different components, including components for transferring digitally encoded content to any of numerous devices, various different types of display components, rendering components, processing components, and other components. In alternative implementations of the current invention, content may be rendered during content transfer according to user selection, according to the queued content for transfer, according to various different orderings and samplings determined by control programs within the kiosk-based retailing systems, or according to other parameters, rules, or inferences. Length of portions of content rendered may vary, depending on projected transfer times. Rendering of selected content during content transfer may also be made available to other users or to a kiosk audience, in order to draw attention to kiosk-based content distribution.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Obviously many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A digitally encoded content distribution system comprising:
a networked computing system;
a control program that runs on the networked computing system;
a user-interface, displayed on a display component and controlled by the control program, that allows a user to select content for transfer to a storage medium or storage device; and
a content-rendering component on which the control program renders content selected by the user while the selected content is transferred to a storage medium or storage device.

2. The digitally encoded content distribution system of claim 1 wherein the content is digitally encoded music selections.

3. The digitally encoded content distribution system of claim 1 wherein user-selected music content is transferred by the content distribution system to one of:
a CD;
a DVD; and
a user music-storage-and-playback device.

4. The digitally encoded content distribution system of claim 1 wherein the content is a digitally encoded movie.

5. The digitally encoded content distribution system of claim 1 wherein user-selected music content is transferred by the content distribution system to one of:
a CD;
a DVD;
a user music-storage-and-playback device;
a laptop computer; and
a notebook computer.

6. The digitally encoded content distribution system of claim 1 wherein the content is a digitally encoded executable program, including a computer game.

7. The digitally encoded content distribution system of claim 1 wherein user-selected music content is transferred by the content distribution system to one of:
a CD;
a DVD;
a user game device;
a laptop computer; and
a notebook computer.

8. The digitally encoded content distribution system of claim 1 wherein the control program renders content selected by the user while the selected content is transferred to a storage medium or storage device by:
queuing selected content to the content rendering component; and
responding to subsequent events.

9. The digitally encoded content distribution system of claim 8 wherein subsequent events include user input to control rendering of the selected content, in response to which the control program queues content indicated by the user to the content rendering component.

10. The digitally encoded content distribution system of claim 8 wherein subsequent events include notification of content-transfer completion, in response to which the control program discontinues rendering of selected content.

11. The digitally encoded content distribution system of claim 8 wherein subsequent events include notification of content-rendering completion, in response to which the control program queues additional content to the content rendering component.

12. A method for entertaining a user of a content distribution system, the method comprising:
providing a user-interface that allows a user to select content for transfer to a storage medium or storage device;
queuing content selected by the user to a content-transferring component; and
queuing content selected by the user to a content-rendering component for rendering to the user while the selected content is transferred to a storage medium or storage device.

13. The method of claim 12 further including, following queuing content selected by the user to a content-rendering component for rendering to the user while the selected content is transferred to a storage medium or storage device:
responding to subsequent events.

14. The method of claim 13 further including, in response to a subsequent event of user input to control rendering of the selected content, queuing content indicated by the user to the content rendering component.

15. The method of claim 13 further including, in response to a subsequent event of notification of notification of content-transfer completion, in discontinuing rendering of selected content.

16. The method of claim 13 further including, in response to a subsequent event of notification of content-rendering completion, queuing additional content to the content rendering component.

17. Computer instructions encoded in a computer-readable medium that carry out a method for entertaining a user of a content distribution system, the method comprising:
providing a user-interface that allows a user to select content for transfer to a storage medium or storage device;
queuing content selected by the user to a content-transferring component; and
queuing content selected by the user to a content-rendering component for rendering to the user while the selected content is transferred to a storage medium or storage device.
